(19) United States
(12) Patent Application Publication
(10) Pub. No.: US 2013/0009874 A1
(43) Pub. Date: Jan. 10, 2013

(54) SHAPE-CHANGEABLE MOUSE

(75) Inventor: WU CHUN-CHE, Taipei (TW)

(73) Assignee: Primax Electronics Ltd., Taipei (TW)

(21) Appl. No.: 13/240,151

(22) Filed: Sep. 22, 2011

(30) Foreign Application Priority Data
Jul. 8, 2011 (TW) 100124183

(51) Int. Cl. G06F 3/033

(52) U.S. Cl. 345/166; 345/163

(57) ABSTRACT

A shape-changeable mouse includes a first casing, a second casing, a push rod, a sliding element and a third casing. The push rod is pivotally coupled with the first casing and the second casing. The second casing has a first positioning hole and a second positioning hole. The sliding element has a positioning post. The third casing is used for storing a sensor. The third casing is rotatable relative to the first casing to lie flat on a sensing surface. In a case that the positioning post is inserted into the first positioning hole, a first angle is defined between the first casing and the second casing. Whereas, in a case that the positioning post is inserted into the second positioning hole, a second angle is defined between the first casing and the second casing.

### FIELD OF THE INVENTION

The present invention relates to a mouse, and more particularly to a shape-changeable mouse.

### BACKGROUND OF THE INVENTION

With increasing development of the graphical interface for the computer system, the mouse for operating the graphical interface becomes one of the most popular computer peripheral devices. As known, the casing of the conventional mouse is a one-piece casing. Since the casing has a simplex shape and the shape fails to be adjusted according to the user's requirement, the frequent use of the mouse may cause discomfort and injury of the user's hand.

For solving the above drawbacks, a structure of a shape-adjustable mouse has been disclosed in for example Taiwanese Patent No. I313428. FIG. 1 is a schematic side view illustrating structure of a conventional mouse disclosed in Taiwanese Patent No. I313428. As shown in FIG. 1, the mouse 100 comprises a casing 110, a first cover plate 120, a second cover plate 130, a first shaft 140 and a second shaft 150. The sidewall W of the casing 110 has a first end part 111 and a second end part 112. A sliding groove 112a is located at the second end part 112. In addition, the first cover plate 120 has a third end part 121 and a fourth end part 122. The second cover plate 130 has a fifth end part 131 and a sixth end part 132. In addition, a sliding block 132a is located at the sixth end part 132.

Please refer to FIG. 1 again. The third end part 121 of the first cover plate 120 is pivotally coupled with the first end part 111 of the casing 110 through the first shaft 140. The fifth end part 131 of the second cover plate 130 is pivotally coupled with the fourth end part 122 of the first cover plate 120 through the second shaft 150. The sixth end part 132 of the second cover plate 130 is pivotally coupled with the second end part 112 of the casing 110 through the sliding block 132a. Please refer to FIG. 1 again. The sliding block 132a is inserted into the sliding groove 112a of the second end part 112. During the sliding block 132a is slid to one of some different positioning points, the second cover plate 130 is rotatable relative to the first cover plate 120. In such way, the shape of the mouse is changeable.

Generally, as the number of positioning points in the sliding groove 112a is increased, the number of adjustable angles provided by the conventional mouse 100 will be increased to meet the requirements of different users. However, the number of adjustable angles provided by the conventional mouse 100 is limited in some situations. For example, if the bending degree between the first cover plate 120 and the second cover plate 130 is too large through the second shaft 150, a larger portion of the third end part 121 of the first cover plate 120 and a larger portion of the sixth end part 132 of the first cover plate 120 are protruded from the bottom of the casing 110. Under this circumstance, the bottom of the casing 110 fails to be in close contact with the sensing surface. As known, for performing normal operations of the optical sensor, the conventional mouse 100 should lie flat on the sensing surface. For maintaining the basic function of detecting the displacement of the conventional mouse, the structure of the conventional mouse 100 can provide limited angular adjustment efficacy. In other words, the conventional mouse 100 fails to meet the preferences and requirements of different users.

### SUMMARY OF THE INVENTION

The present invention provides a shape-changeable mouse capable of being operated at various angles.

In accordance with an aspect of the present invention, there is provided a shape-changeable mouse. The shape-changeable mouse includes a first casing, a second casing, a push rod, a sliding element and a third casing. The first casing includes a convex structure. The second casing includes a first concave structure and a positioning part. The convex structure is accommodated within the first concave structure. The positioning part has a first positioning hole and a second positioning hole. The push rod is pivotally coupled with the first casing and the second casing. The sliding element is penetrated through the first casing and located at a side of the push rod, and includes a positioning post. When the positioning post is inserted into the first positioning hole of the positioning part, a first angle is defined between the first casing and the second casing. After the sliding element is pushed by the push rod and the positioning post is detached from the first positioning hole, if the first casing is rotated relative to the second casing and the positioning post is inserted into the second positioning hole of the positioning part, a second angle is defined between the first casing and the second casing. The third casing is used for storing a sensor. The third casing is pivotally coupled with the first casing. The third casing is rotatable relative to the first casing, so that the third casing lies flat on a sensing surface.

In an embodiment, the sensor is an optical sensor.

In an embodiment, the first casing further includes a second concave structure for accommodating the third casing.

In an embodiment, the shape-changeable mouse further includes a damper hinge. The first casing and the third casing are pivotally coupled with each other through the damper hinge.

In an embodiment, the shape-changeable mouse further includes two buttons, a main circuit board and a battery holder, which are disposed within the first casing.

In an embodiment, the shape-changeable mouse further includes two buttons, a main circuit board and a battery holder, which are disposed within the first casing. In addition, the second casing is a battery box for storing a battery.

In an embodiment, the shape-changeable mouse further includes a first elastic element. A first end of the first elastic element is sustained against the sliding element. When the sliding element is pushed by the push rod, the first elastic element is compressed by the sliding element to result in a first elastic potential energy for restoring the sliding element.

In an embodiment, the first elastic element is a compression spring.

In an embodiment, the shape-changeable mouse further includes a second elastic element. The push rod includes a push block. The second elastic element is sheathed around the push rod. A first end of the second elastic element is sustained against the push block. When the sliding element is pushed by the push rod, the second elastic element is compressed by the push block to result in a second elastic potential energy for restoring the push rod.

In an embodiment, the second elastic element is a compression spring.

In an embodiment, a second end of the second elastic element is sustained against the positioning part of the second casing.

In an embodiment, the second casing further includes a perforation, and the push block is penetrated through the perforation. The push block has a pressing surface for moving the push rod, and the push rod is pushed forward through the pressing surface.

In an embodiment, a second end of the first elastic element is sustained against an inner wall of the convex structure of the first casing.

In an embodiment, a stopping piece is disposed within the convex structure of the first casing, wherein a second end of the first elastic element is sustained against the stopping piece.

In an embodiment, the positioning part is a metal piece.

In an embodiment, the second casing and the positioning part are integrally formed.

In an embodiment, the positioning part of the second casing further includes a third positioning hole. When the positioning post is inserted into the third positioning hole of the positioning part, a third angle is defined between the first casing and the second casing.

In accordance with another aspect of the present invention, there is provided a shape-changeable mouse. The shape-changeable mouse includes a first casing, a second casing, a push rod, a sliding element and a third casing. The first casing includes a convex structure. The second casing includes a first concave structure and a positioning part. The convex structure is accommodated within the first concave structure. The positioning part has a first positioning hole and a second positioning hole. The push rod is pivotally coupled with the first casing and the second casing. The sliding element is penetrated through the first casing and located at a side of the push rod, and includes a positioning post. When the positioning post is inserted into the first positioning hole of the positioning part, a first angle is defined between the first casing and the second casing. After the sliding element is pushed by the push rod and the positioning post is detached from the first positioning hole, if the first casing is rotated relative to the second casing and the positioning post is inserted into the second positioning hole of the positioning part, a second angle is defined between the first casing and the second casing. The third casing is used for storing a sensor. The third casing is pivotally coupled with the second casing, and the third casing is rotatable relative to the second casing, so that the third casing lies flat on a sensing surface.

In an embodiment, the sensor is an optical sensor.

In an embodiment, the second casing further includes a second concave structure for accommodating the third casing.

In an embodiment, the shape-changeable mouse further includes a damper hinge. The second casing and the third casing are pivotally coupled with each other through the damper hinge.

In an embodiment, the shape-changeable mouse further includes two buttons, a main circuit board and a battery holder, which are disposed within the second casing.

In an embodiment, the shape-changeable mouse further includes two buttons and a main circuit board, which are disposed within the second casing. In addition, the first casing is a battery box for storing a battery.

In an embodiment, the shape-changeable mouse further includes a first elastic element. A first end of the first elastic element is sustained against the sliding element. When the sliding element is pushed by the push rod, the first elastic element is compressed by the sliding element to result in a first elastic potential energy for restoring the sliding element.

In an embodiment, the first elastic element is a compression spring.

In an embodiment, the shape-changeable mouse further includes a second elastic element. The push rod includes a push block. The second elastic element is sheathed around the push rod. A first end of the second elastic element is sustained against the push block. When the sliding element is pushed by the push rod, the second elastic element is compressed by the push block to result in a second elastic potential energy for restoring the push rod.

In an embodiment, the second elastic element is a compression spring.

In an embodiment, a second end of the second elastic element is sustained against the positioning part of the second casing.

In an embodiment, the second casing further includes a perforation, and the push block is penetrated through the perforation. The push block has a pressing surface for moving the push rod, and the push rod is pushed forward through the pressing surface.

In an embodiment, a second end of the first elastic element is sustained against an inner wall of the convex structure of the first casing.

In an embodiment, a stopping piece is disposed within the concave structure of the first casing. A second end of the first elastic element is sustained against the stopping piece.

In an embodiment, the positioning part is a metal piece.

In an embodiment, the second casing and the positioning part are integrally formed.

In an embodiment, the positioning part of the second casing further includes a third positioning hole. When the positioning post is inserted into the third positioning hole of the positioning part, a third angle is defined between the first casing and the second casing.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic side view illustrating structure of a conventional mouse disclosed in Taiwanese Patent No. I313428;

FIG. 2 is a schematic exploded view illustrating a shape-changeable mouse according to a first embodiment of the present invention;

FIG. 3 schematically illustrates a first action of the shape-changeable mouse according to the first embodiment of the present invention;

FIG. 4 schematically illustrates a second action of the shape-changeable mouse according to the first embodiment of the present invention;

FIG. 5 schematically illustrates a first angle between the first casing and a second casing of the shape-changeable mouse according to the first embodiment of the present invention;

FIG. 6 schematically illustrates a second angle between the first casing and a second casing of the shape-changeable mouse according to the first embodiment of the present invention;

FIG. 7 schematically illustrates a third angle between the first casing and a second casing of the shape-changeable mouse according to the first embodiment of the present invention;

FIG. 8 schematically illustrates a shape-changeable mouse according to a second embodiment of the present invention;

FIG. 9 schematically illustrates a shape-changeable mouse according to a third embodiment of the present invention;

FIG. 10 schematically illustrates a second casing of a shape-changeable mouse according to a fourth embodiment of the present invention;

FIG. 11 is a schematic exploded view illustrating a shape-changeable mouse according to a fifth embodiment of the present invention;

FIG. 12 schematically illustrates a first action of the shape-changeable mouse according to the fifth embodiment of the present invention;

FIG. 13 schematically illustrates a second action of the shape-changeable mouse according to the fifth embodiment of the present invention;

FIG. 14 schematically illustrates a first angle between the first casing and a second casing of the shape-changeable mouse according to the fifth embodiment of the present invention;

FIG. 15 schematically illustrates a second angle between the first casing and a second casing of the shape-changeable mouse according to the fifth embodiment of the present invention;

FIG. 16 schematically illustrates a third angle between the first casing and a second casing of the shape-changeable mouse according to the fifth embodiment of the present invention;

FIG. 17 schematically illustrates a shape-changeable mouse according to a sixth embodiment of the present invention;

FIG. 18 schematically illustrates a shape-changeable mouse according to a seventh embodiment of the present invention; and

FIG. 19 schematically illustrates a second casing of a shape-changeable mouse according to an eighth embodiment of the present invention.

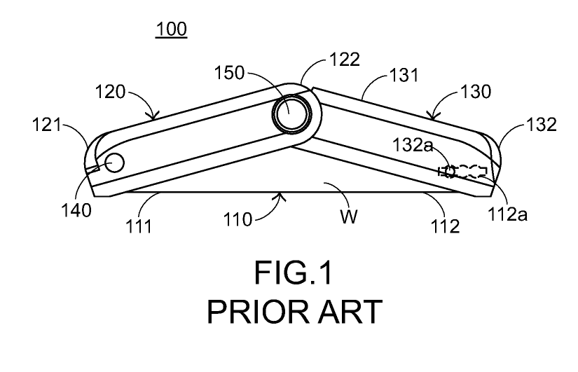

### DETAILED DESCRIPTION OF THE PREFERRED EMBODIMENT

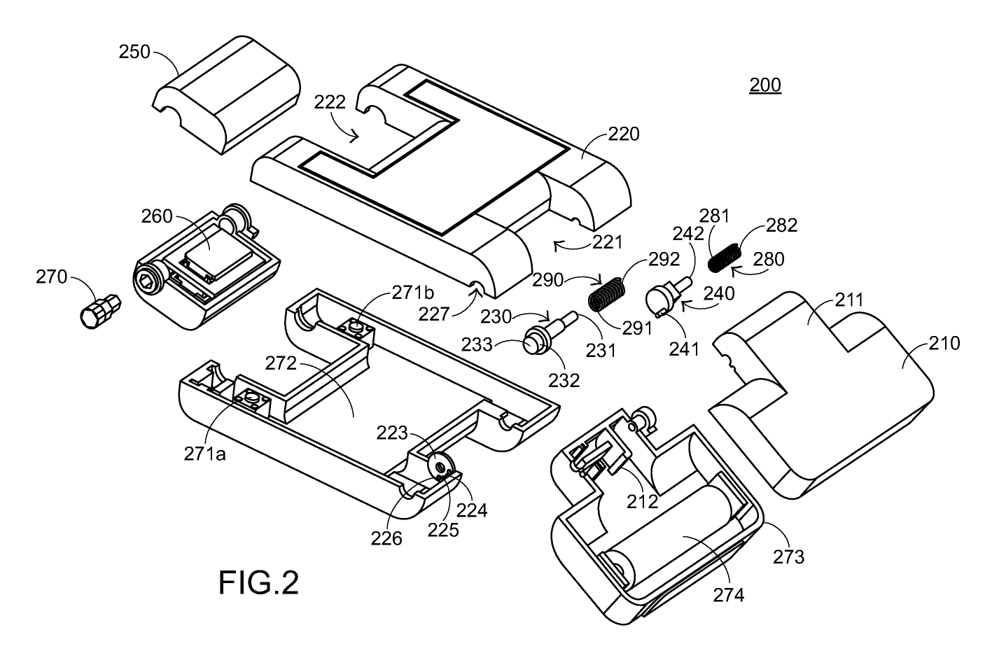

FIG. 2 is a schematic exploded view illustrating a shape-changeable mouse according to a first embodiment of the present invention. The shape-changeable mouse 200 of the first embodiment comprises a first casing 210, a second casing 220, a push rod 230, a sliding element 240, a third casing 250, a sensor 260, a damper hinge 270, two buttons 271a, 271b, a main circuit board 272, a first elastic element 280 and a second elastic element 290. The first casing 210 has a convex structure 211. The second casing 220 has a first concave structure 221, a second concave structure 222, a positioning part 223 and a perforation 227. The push rod 230 has a push block 232. The sliding element 240 has a positioning post 241. The positioning part 223 is a metal piece having a first positioning hole 224, a second positioning hole 225 and a third positioning hole 226.

Please refer to FIG. 2 again. The convex structure 211 of the first casing 210 is accommodated within the first concave structure 221 of the second casing 220. The third casing 250 is accommodated within the second concave structure 222 of the second casing 220. The sensor 260 is stored within the third casing 250. The third casing 250 is pivotally coupled with the second casing 220 through the damper hinge 270, so that the third casing 250 is rotatable relative to the second casing 220. In such way, the third casing 250 can lie flat on a sensing surface S (see FIG. 5, 6 or 7). In this embodiment, the mouse 200 is a wireless optical mouse, and the sensor is an optical sensor. The buttons 271a and 271b and the main circuit board 272 are disposed within the second casing 220. The first casing 210 is used as a battery box 273 for storing a battery 274.

Please refer to FIG. 2 again. The first elastic element 280 (e.g. a compression spring) is sheathed around the sliding element 240. A first end 281 of the first elastic element 280 is sustained against the sliding element 240. A second end 282 of the first elastic element 280 is sustained against a stopping piece 212, which is disposed within the convex structure 211 of the first casing 210. It is noted that the sliding element 240 is not in contact with the stopping piece 212 in the convex structure 211. That is, there is a sliding space between the end 242 of the sliding element 240 and the stopping piece 212. The sliding element 240 is movable back and forth along the sliding space.

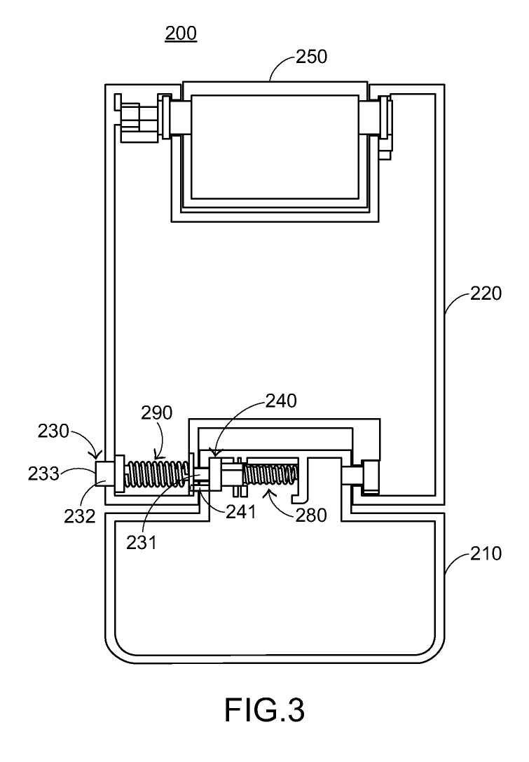

Hereinafter, the relationship between the push rod 230 and the sliding element 240 will be illustrated with reference to FIGS. 2 and 3. FIG. 3 schematically illustrates a first action of the shape-changeable mouse according to the first embodiment of the present invention. As shown in FIGS. 2 and 3, the push block 232 of the push rod 230 is penetrated through the perforation 227 of the second casing 220. In addition, the push block 232 has a pressing surface 233. By exerting a force on the pressing surface 233, the push rod 230 may be pushed forward.

In addition, the push rod 230 is pivotally coupled with the first casing 210 and the second casing 220. The sliding element 240 is penetrated through the first casing 210, and located at a side of the push rod 230. In a case that no force is exerted on the pressing surface 233 of the push rod 230, the positioning post 241 of the sliding element 240 is inserted into one of the first positioning hole 224, the second positioning hole 225 and the third positioning hole 226 of the positioning part 223 for fixing the first casing 210 and the second casing 220.

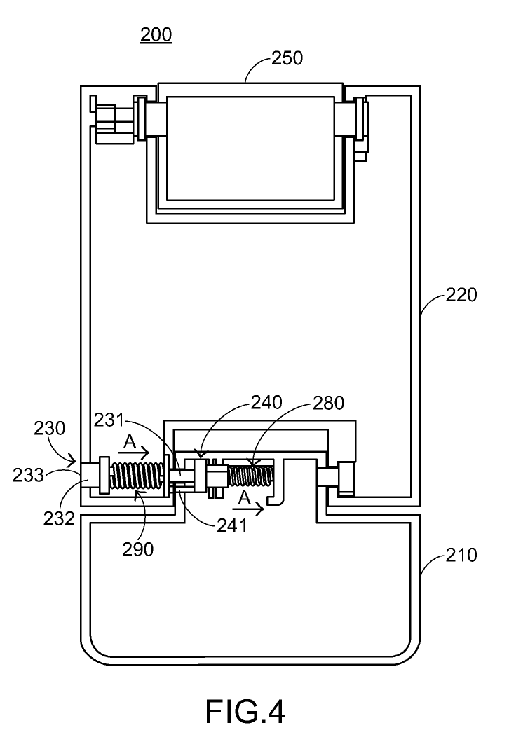

Please refer to FIGS. 2 and 4. FIG. 4 schematically illustrates a second action of the shape-changeable mouse according to the first embodiment of the present invention. In response to a force exerted on the pressing surface 233 of the push rod 230 in a direction A, the sliding element 240 is pushed by a first end 231 of the push rod 230 to be moved in the direction A. Consequently, the positioning post 241 is detached from the first positioning hole 224, the second positioning hole 225 or the third positioning hole 226 of the positioning part 223. Under this circumstance, the fixed states of the first casing 210 and the second casing 220 are released. Meanwhile, the first casing 210 is rotatable relative to the second casing 220, and thus the shape of the mouse 200 is adjustable by the user. Moreover, as the sliding element 240 is moved in the direction A, the first elastic element 280 is compressed to result in a first elastic potential energy.

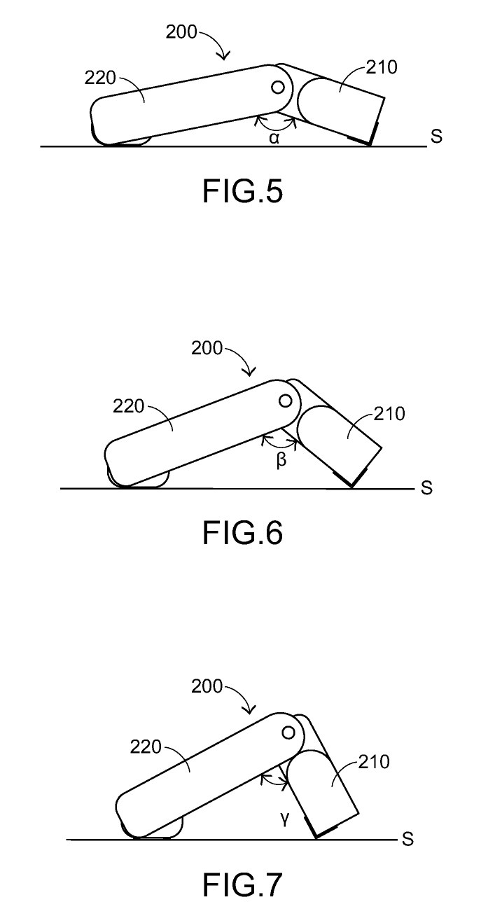

In a case that the force exerted on the pressing surface 233 is eliminated, as shown in FIG. 3, the sliding element 240 is returned to the original position due to the released first elastic potential energy. Since the push rod 230 is pushed by the sliding element 240, the push rod 230 is also returned to the original position. Meanwhile, the positioning post 241 of the sliding element 240 is inserted into one of the first positioning hole 224, the second positioning hole 225 and the third positioning hole 226 of the positioning part 223 again for fixing the first casing 210 and the second casing 220. In a case that the positioning post 241 of the sliding element 240 is inserted into the first positioning hole 224 of the positioning part 223, a first angle α is defined between the first casing 210 and the second casing 220 (see FIG. 5). Please refer to FIG. 5, which schematically illustrates a first angle between the first casing and a second casing of the shape-changeable mouse according to the first embodiment of the present invention. In a case that the positioning post 241 of the sliding element 240 is inserted into the second positioning hole 225 of the positioning part 223, a second angle β is defined between the first casing 210 and the second casing 220 (see FIG. 6). Please refer to FIG. 6, which schematically illustrates a second angle between the first casing and a second casing of the shape-changeable mouse according to the first embodiment of the present invention. In a case that the positioning post 241 of the sliding element 240 is inserted into the third positioning hole 226 of the positioning part 223, a third angle γ is defined between the first casing 210 and the second casing 220 (see FIG. 7). Please refer to FIG. 7, which schematically illustrates a third angle between the first casing and a second casing of the shape-changeable mouse according to the first embodiment of the present invention.

That is, in the cooperation of the positioning post 241 of the sliding element 240 with the first positioning hole 224, the second positioning hole 225 or the third positioning hole 226 of the positioning part 223, the shape of the mouse 200 is changeable to meet the requirements of different users. It is noted that the number of positioning holes is not restricted to three and may be varied according to the practical requirements.

In this embodiment, the second elastic element 290 (e.g. a compression spring) is disposed on the push rod 230 for increasing the efficacy of restoring the push rod 230 and the sliding element 240. As shown in FIGS. 2 and 3, the second elastic element 290 is sheathed around the push rod 230. A first end 291 of the second elastic element 290 is sustained against the push block 232 of the push rod 230. A second end 292 of the second elastic element 290 is sustained against the positioning part 223 of the second casing 220. In response to a force exerted on the pressing surface 233 of the push rod 230 in the direction A (see FIGS. 2 and 4), the push rod 230 is moved the direction A. Consequently, the second elastic element 290 is compressed by the push block 232 of the push rod 230 to result in a second elastic potential energy. In a case that the force is eliminated (see FIG. 3), the push rod 230 and the sliding element 240 are restored and returned to their original positions due to the released first elastic potential energy and the released second elastic potential energy. It is noted that the second elastic element 290 may be selectively omitted. In a case that the second elastic element 290 is omitted, the push rod 230 and the sliding element 240 can be returned to their original positions due to the released first elastic potential energy.

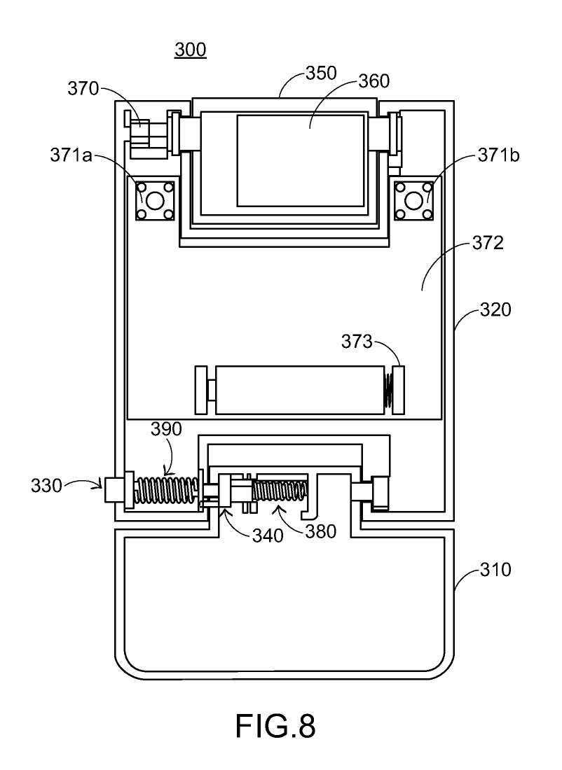

Hereinafter, a second embodiment of the present invention will be illustrated with reference to FIG. 8. FIG. 8 schematically illustrates a shape-changeable mouse according to a second embodiment of the present invention. As shown in FIG. 8, the shape-changeable mouse 300 comprises a first casing 310, a second casing 320, a push rod 330, a sliding element 340, a third casing 350, a sensor 360, a damper hinge 370, two buttons 371a, 371b, a main circuit board 372, a battery holder 373, a first elastic element 380 and a second elastic element 390.

In this embodiment, the buttons 371a and 371b, the main circuit board 372 and the battery holder 373 are disposed within the second casing 320. The other configurations of the mouse 300 of the second embodiment are similar to those of the first embodiment (see FIG. 2), and are not redundantly described herein.

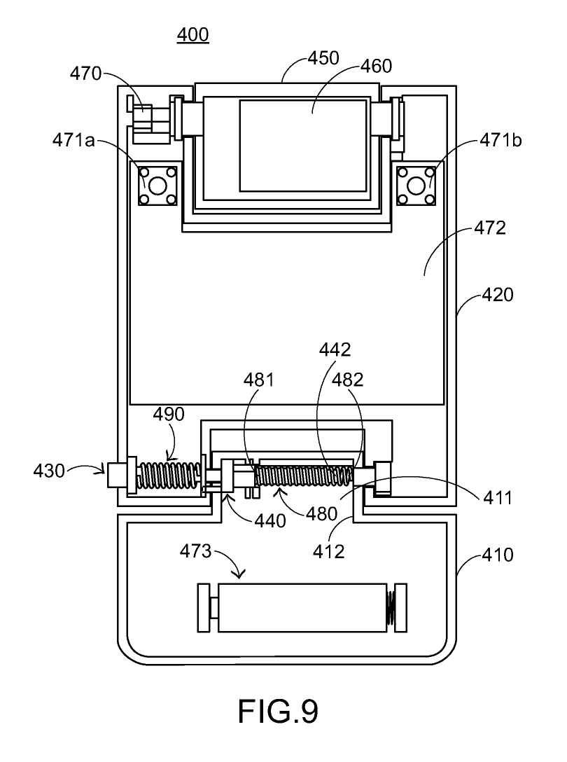

Hereinafter, a third embodiment of the present invention will be illustrated with reference to FIG. 9. FIG. 9 schematically illustrates a shape-changeable mouse according to a third embodiment of the present invention. As shown in FIG. 9, the shape-changeable mouse 400 comprises a first casing 410, a second casing 420, a push rod 430, a sliding element 440, a third casing 450, a sensor 460, a damper hinge 470, two buttons 471a, 471b, a main circuit board 472, a first elastic element 480 and a second elastic element 490. The first casing 410 comprises a convex structure 411. In addition, the first casing 410 is used as a battery box 473.

In this embodiment, the first elastic element 480 (e.g. a compression spring) is sheathed around the sliding element 440. A first end 481 of the first elastic element 480 is sustained against the sliding element 440. A second end 482 of the first elastic element 480 is sustained against an inner wall 412 of the convex structure 411 of the first casing 410. The other configurations of the mouse 400 of the third embodiment are similar to those of the first embodiment (see FIG. 2), and are not redundantly described herein. It is noted that the sliding element 440 is not in contact with the inner wall 412 of the convex structure 411. That is, there is a sliding space between the end 442 of the sliding element 440 and the inner wall 412. The sliding element 440 is movable back and forth along the sliding space.

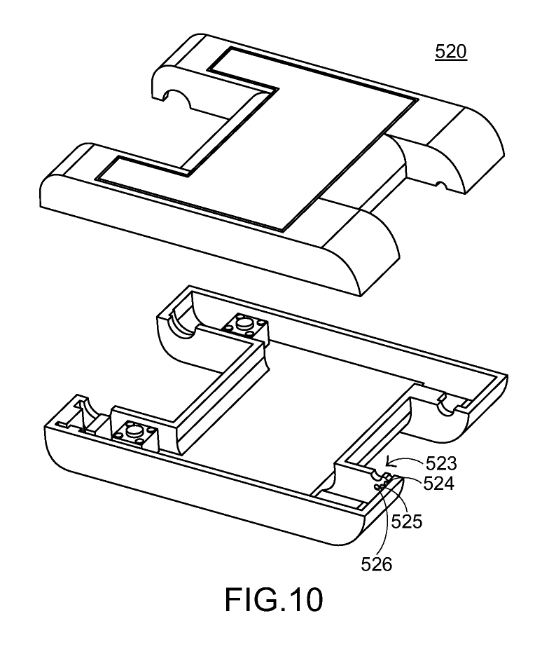

Hereinafter, a fourth embodiment of the present invention will be illustrated with reference to FIG. 10. FIG. 10 schematically illustrates a second casing of a shape-changeable mouse according to a fourth embodiment of the present invention. In this embodiment, the positioning part 523 is integrally formed with the second casing 520. The first positioning hole 524, the second positioning hole 525 and the third positioning hole 526 of the positioning part 523 are formed in the second casing 520. The other configurations of the mouse 500 of the fourth embodiment are similar to those of the first embodiment (see FIG. 2), and are not redundantly described herein.

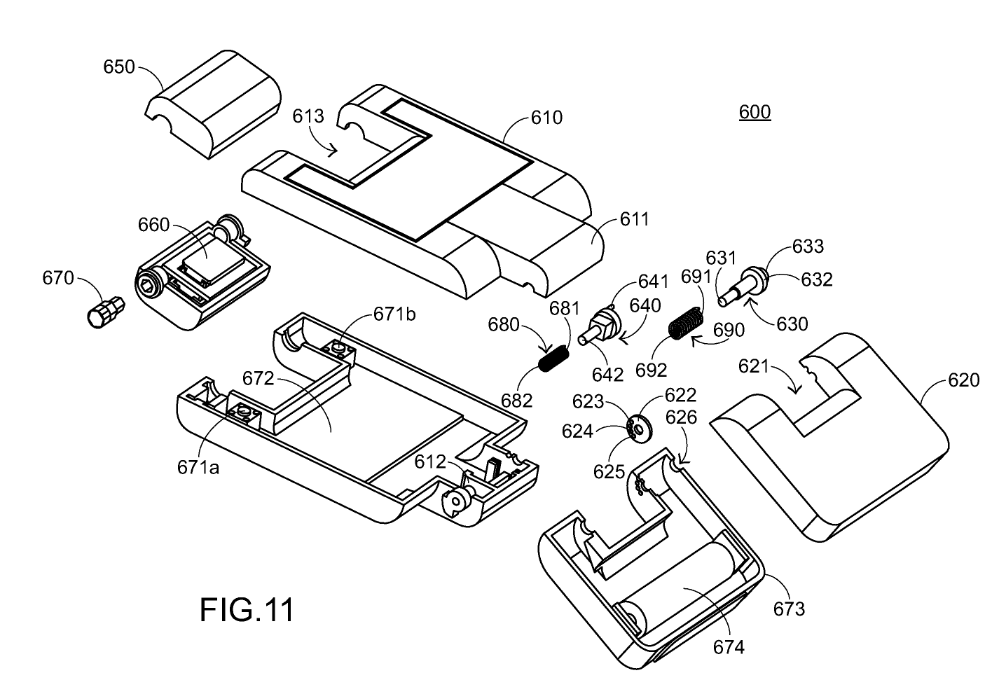

FIG. 11 is a schematic exploded view illustrating a shape-changeable mouse according to a fifth embodiment of the present invention. The shape-changeable mouse 600 of the first embodiment comprises a first casing 610, a second casing 620, a push rod 630, a sliding element 640, a third casing 650, a sensor 660, a damper hinge 670, two buttons 671a, 671b, a main circuit board 672, a first elastic element 680 and a second elastic element 690. The first casing 610 has a convex structure 611 and a second concave structure 613. The second casing 620 has a first concave structure 621, a positioning part 622 and a perforation 626. The push rod 630 has a push block 632. The sliding element 640 has a positioning post 641. The positioning part 622 is a metal piece having a first positioning hole 623, a second positioning hole 624 and a third positioning hole 625.

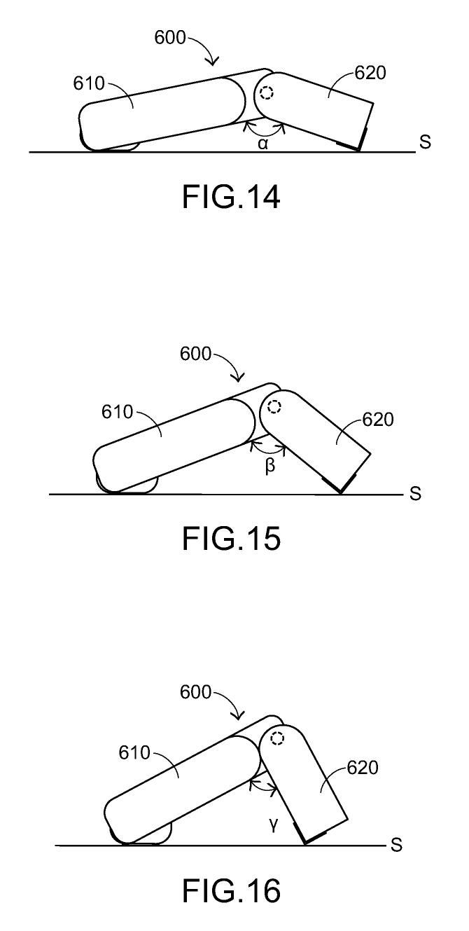

Please refer to FIG. 11 again. The convex structure 611 of the first casing 610 is accommodated within the first concave structure 621 of the second casing 620. The third casing 650 is accommodated within the second concave structure 613 of the first casing 610. The sensor 660 is stored within the third casing 650. The third casing 650 is pivotally coupled with the first casing 610 through the damper hinge 670, so that the third casing 650 is rotatable relative to the first casing 610. In such way, the third casing 650 can lie flat on a sensing surface S (see FIG. 14, 15 or 16). In this embodiment, the mouse 600 is a wireless optical mouse, and the sensor 660 is an optical sensor. The buttons 671a and 671b and the main circuit board 672 are disposed within the first casing 610. The second casing 610 is used as a battery box 673 for storing a battery 674.

Please refer to FIG. 11 again. The first elastic element 680 (e.g. a compression spring) is sheathed around the sliding element 640. A first end 681 of the first elastic element 680 is sustained against the sliding element 640. A second end 682 of the first elastic element 680 is sustained against a stopping piece 612, which is disposed within the convex structure 611 of the first casing 610. It is noted that the sliding element 640 is not in contact with the stopping piece 612 in the convex structure 611. That is, there is a sliding space between the end 642 of the sliding element 640 and the stopping piece 612. The sliding element 640 is movable back and forth along the sliding space.

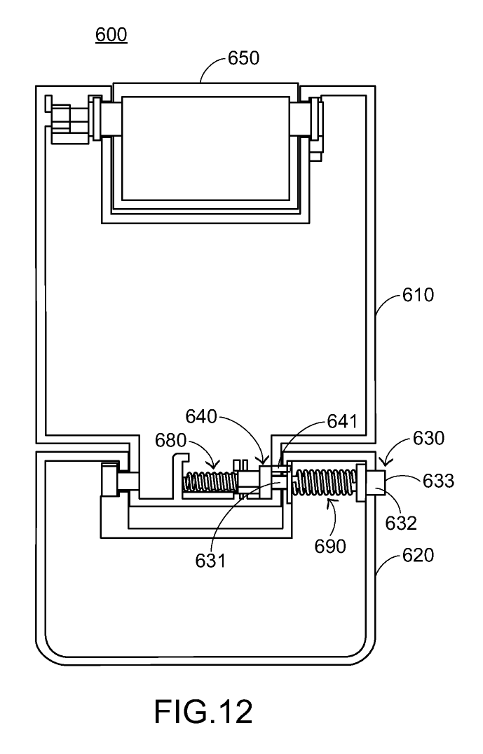

Hereinafter, the relationship between the push rod 630 and the sliding element 640 will be illustrated with reference to FIGS. 11 and 12. FIG. 12 schematically illustrates a first action of the shape-changeable mouse according to the fifth embodiment of the present invention. As shown in FIGS. 11 and 12, the push block 632 of the push rod 630 is penetrated through the perforation 626 of the second casing 620. In addition, the push block 632 has a pressing surface 633. By exerting a force on the pressing surface 633, the push rod 630 may be pushed forward.

In addition, the push rod 630 is pivotally coupled with the first casing 610 and the second casing 620. The sliding element 640 is penetrated through the first casing 610, and located at a side of the push rod 630. In a case that no force is exerted on the pressing surface 633 of the push rod 630, the positioning post 641 of the sliding element 640 is inserted into one of the first positioning hole 623, the second positioning hole 624 and the third positioning hole 625 of the positioning part 622 for fixing the first casing 610 and the second casing 620.

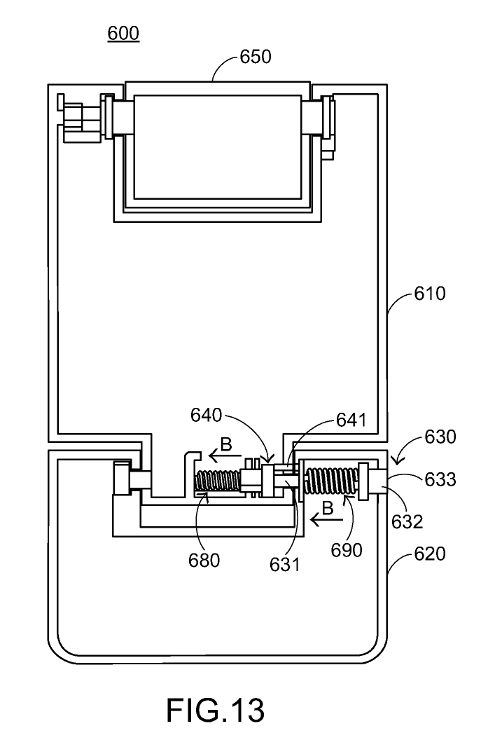

Please refer to FIGS. 11 and 13. FIG. 13 schematically illustrates a second action of the shape-changeable mouse according to the fifth embodiment of the present invention. In response to a force exerted on the pressing surface 633 of the push rod 630 in a direction B, the sliding element 640 is pushed by a first end 631 of the push rod 630 to be moved in the direction B. Consequently, the positioning post 641 is detached from the first positioning hole 623, the second positioning hole 624 or the third positioning hole 625 of the positioning part 622. Under this circumstance, the fixed states of the first casing 610 and the second casing 620 are released. Meanwhile, the first casing 610 is rotatable relative to the second casing 620, and thus the shape of the mouse 600 is adjustable by the user. Moreover, as the sliding element 640 is moved in the direction B, the first elastic element 680 is compressed to result in a first elastic potential energy.

In a case that the force exerted on the pressing surface 633 is eliminated, as shown in FIG. 12, the sliding element 640 is returned to the original position due to the released first elastic potential energy. Since the push rod 630 is pushed by the sliding element 640, the push rod 630 is also returned to the original position. Meanwhile, the positioning post 641 of the sliding element 640 is inserted into one of the first positioning hole 623, the second positioning hole 624 and the third positioning hole 625 of the positioning part 622 again for fixing the first casing 610 and the second casing 620. In a case that the positioning post 641 of the sliding element 640 is inserted into the first positioning hole 623 of the positioning part 622, a first angle α is defined between the first casing 610 and the second casing 620 (see FIG. 14). Please refer to FIG. 14, which schematically illustrates a first angle between the first casing and a second casing of the shape-changeable mouse according to the fifth embodiment of the present invention. In a case that the positioning post 641 of the sliding element 640 is inserted into the second positioning hole 624 of the positioning part 622, a second angle β is defined between the first casing 610 and the second casing 620 (see FIG. 15). Please refer to FIG. 15, which schematically illustrates a second angle between the first casing and a second casing of the shape-changeable mouse according to the fifth embodiment of the present invention. In a case that the positioning post 641 of the sliding element 640 is inserted into the third positioning hole 625 of the positioning part 622, a third angle γ is defined between the first casing 610 and the second casing 620 (see FIG. 16). Please refer to FIG. 16, which schematically illustrates a third angle between the first casing and a second casing of the shape-changeable mouse according to the fifth embodiment of the present invention. That is, in the cooperation of the positioning post 641 of the sliding element 640 with the first positioning hole 623, the second positioning hole 624 or the third positioning hole 625 of the positioning part 622, the shape of the mouse 600 is changeable to meet the requirements of different users. It is noted that the number of positioning holes is not restricted to three and may be varied according to the practical requirements.

In this embodiment, the second elastic element 690 (e.g. a compression spring) is disposed on the push rod 630 for increasing the efficacy of restoring the push rod 630 and the sliding element 640. As shown in FIGS. 11 and 12, the second elastic element 690 is sheathed around the push rod 630. A first end 691 of the second elastic element 690 is sustained against the push block 632 of the push rod 630. A second end 692 of the second elastic element 690 is sustained against the positioning part 622 of the second casing 620. In response to a force exerted on the pressing surface 633 of the push rod 630 in the direction B (see FIGS. 11 and 13), the push rod 630 is moved the direction B. Consequently, the second elastic element 690 is compressed by the push block 632 of the push rod 630 to result in a second elastic potential energy. In a case that the force is eliminated (see FIG. 12), the push rod 630 and the sliding element 640 are restored and returned to their original positions due to the released first elastic potential energy and the released second elastic potential energy. It is noted that the second elastic element 690 may be selectively omitted. In a case that the second elastic element 690 is omitted, the push rod 630 and the sliding element 640 can be returned to their original positions due to the released first elastic potential energy

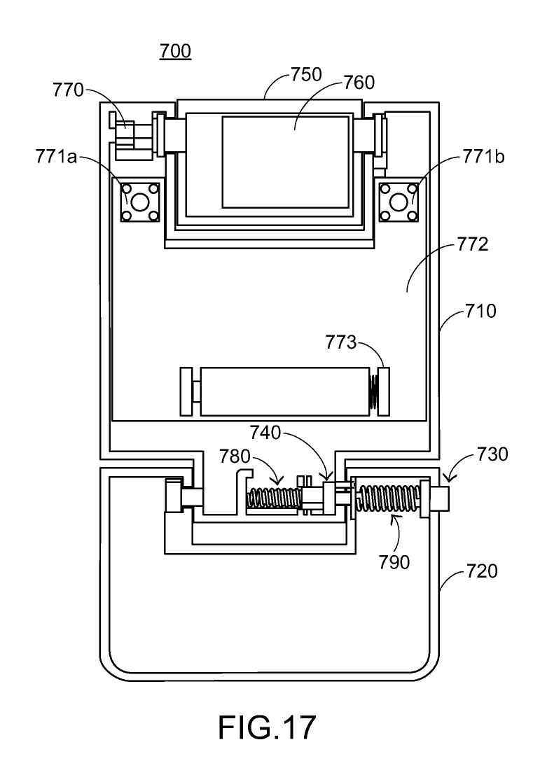

Hereinafter, a sixth embodiment of the present invention will be illustrated with reference to FIG. 17. FIG. 17 schematically illustrates a shape-changeable mouse according to a sixth embodiment of the present invention. As shown in FIG. 17, the shape-changeable mouse 700 comprises a first casing 710, a second casing 720, a push rod 730, a sliding element 740, a third casing 750, a sensor 760, a damper hinge 770, two buttons 771a, 771b, a main circuit board 772, a battery holder 773, a first elastic element 780 and a second elastic element 790.

In this embodiment, the buttons 771a and 771b, the main circuit board 772 and the battery holder 773 are disposed within the first casing 710. The other configurations of the mouse 700 of the sixth embodiment are similar to those of the fifth embodiment (see FIG. 11), and are not redundantly described herein.

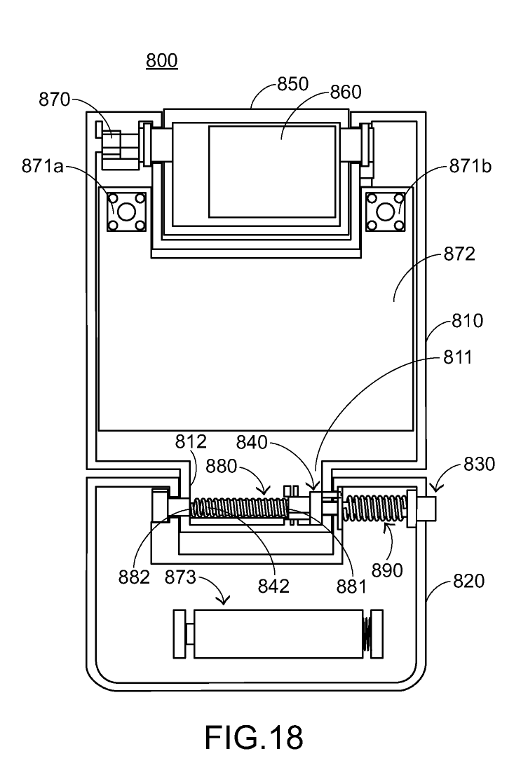

Hereinafter, a seventh embodiment of the present invention will be illustrated with reference to FIG. 18. FIG. 18 schematically illustrates a shape-changeable mouse according to a seventh embodiment of the present invention. As shown in FIG. 18, the shape-changeable mouse 800 comprises a first casing 810, a second casing 820, a push rod 830, a sliding element 840, a third casing 850, a sensor 860, a damper hinge 870, two buttons 871a, 871b, a main circuit board 872, a first elastic element 880 and a second elastic element 890. The first casing 810 comprises a convex structure 811. In addition, the first casing 810 is used as a battery box 873.

In this embodiment, the first elastic element 880 (e.g. a compression spring) is sheathed around the sliding element 840. A first end 881 of the first elastic element 880 is sustained against the sliding element 840. A second end 882 of the first elastic element 880 is sustained against an inner wall 812 of the convex structure 811 of the first casing 810. The other configurations of the mouse 800 of the seventh embodiment are similar to those of the fifth embodiment (see FIG. 11), and are not redundantly described herein. It is noted that the sliding element 840 is not in contact with the inner wall 812 of the convex structure 811. That is, there is a sliding space between the end 842 of the sliding element 840 and the inner wall 812. The sliding element 840 is movable back and forth along the sliding space.

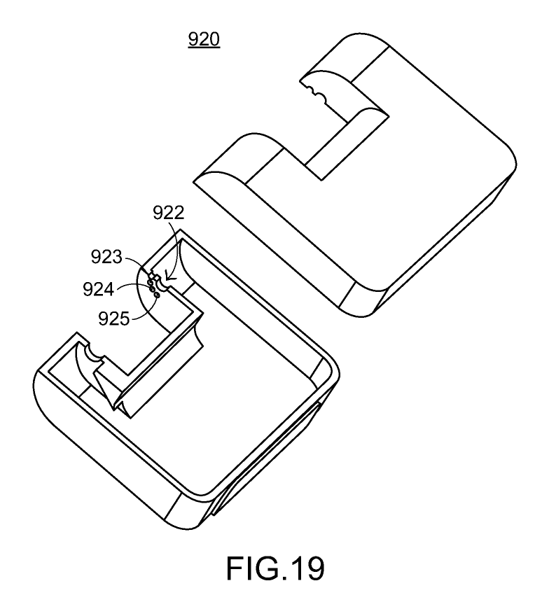

Hereinafter, an eighth embodiment of the present invention will be illustrated with reference to FIG. 19. FIG. 19 schematically illustrates a second casing of a shape-changeable mouse according to an eighth embodiment of the present invention. In this embodiment, the positioning part 922 is integrally formed with the second casing 920. The first positioning hole 923, the second positioning hole 924 and the third positioning hole 925 of the positioning part 922 are formed in the second casing 920. The other configurations of the mouse 900 of the eighth embodiment are similar to those of the fifth embodiment (see FIG. 11), and are not redundantly described herein.

From the above description, the shape-changeable mouse has a positioning part at a second casing thereof. In addition, a push rod is pivotally coupled with the first casing and the second casing. By allowing the positioning post of the sliding element to be detached from or inserted into one of the positioning holes, a specified angle is defined between the first casing and the second casing. In a case that the positioning post of the sliding element is inserted into the first positioning hole, a first angle is defined between the first casing and the second casing. Moreover, after the sliding element is pushed by the push rod and the positioning post is detached from the first positioning hole, the first casing is rotated relative to the second casing and then the positioning post is inserted into the second positioning hole of the positioning part, so that a second angle is defined between the first casing and the second casing.

Due to the above-mentioned positioning structures, various angles between the first casing and the second casing may be adjusted without the need of using the casing bottom. In addition, even if the bending degree between the first casing and the second casing is too large, the problem of causing detachment between the casing bottom and the sensing surface will be avoided. Moreover, since the sensor is stored within the third casing and the third casing is accommodated with the second concave structure of the first casing or the second casing, the third casing is rotatable relative to the first casing or the second casing. Regardless of whether the angle between the first casing and the second casing is, the third casing are always in close contact with the sensing surface, so that the sensor is effective to detect the displacement of the mouse. On the premise that the mouse is normally operated, the angular adjustment of the shape-changeable mouse of the present invention can meet the preferences and requirements of different users

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A shape-changeable mouse, comprising:
a first casing comprising a convex structure;
a second casing comprising a first concave structure and a positioning part, wherein said convex structure is accommodated within said first concave structure, and said positioning part has a first positioning hole and a second positioning hole;
a push rod pivotally coupled with said first casing and said second casing;
a sliding element penetrated through said first casing and located at a side of said push rod, and comprising a positioning post, wherein when said positioning post is inserted into said first positioning hole of said positioning part, a first angle is defined between said first casing and said second casing, wherein after said sliding element is pushed by said push rod and said positioning post is detached from said first positioning hole, if said first casing is rotated relative to said second casing and said positioning post is inserted into said second positioning hole of said positioning part, a second angle is defined between said first casing and said second casing; and
a third casing for storing a sensor, wherein said third casing is pivotally coupled with said first casing, and said third casing is rotatable relative to said first casing, so that said third casing lies flat on a sensing surface.

2. The shape-changeable mouse according to claim 1 wherein said sensor is an optical sensor.

3. The shape-changeable mouse according to claim 1 wherein said first casing further comprises a second concave structure for accommodating said third casing.

4. The shape-changeable mouse according to claim 1 further comprising a damper hinge, wherein said first casing and said third casing are pivotally coupled with each other through said damper hinge.

5. The shape-changeable mouse according to claim 1 further comprising two buttons, a main circuit board and a battery holder, which are disposed within said first casing.

6. The shape-changeable mouse according to claim 1 further comprising two buttons and a main circuit board, which are disposed within said first casing, wherein said second casing is a battery box for storing a battery.

7. The shape-changeable mouse according to claim 1 further comprising a first elastic element, wherein a first end of said first elastic element is sustained against said sliding element, wherein when said sliding element is pushed by said push rod, said first elastic element is compressed by said sliding element to result in a first elastic potential energy for restoring said sliding element.

8. The shape-changeable mouse according to claim 7 wherein said first elastic element is a compression spring.

9. The shape-changeable mouse according to claim 7 further comprising a second elastic element, wherein said push rod comprises a push block, said second elastic element is sheathed around said push rod, and a first end of said second elastic element is sustained against said push block, wherein when said sliding element is pushed by said push rod, said second elastic element is compressed by said push block to result in a second elastic potential energy for restoring said push rod.

10. The shape-changeable mouse according to claim 9 wherein said second elastic element is a compression spring.

11. The shape-changeable mouse according to claim 9 wherein a second end of said second elastic element is sustained against said positioning part of said second casing.

12. The shape-changeable mouse according to claim 9 wherein said second casing further comprises a perforation, and said push block is penetrated through said perforation, wherein said push block has a pressing surface for moving said push rod, and said push rod is pushed forward through said pressing surface.

13. The shape-changeable mouse according to claim 7 wherein a second end of said first elastic element is sustained against an inner wall of said convex structure of said first casing.

14. The shape-changeable mouse according to claim 7 wherein a stopping piece is disposed within said concave structure of said first casing, wherein a second end of said first elastic element is sustained against said stopping piece.

15. The shape-changeable mouse according to claim 1 wherein said positioning part is a metal piece.

16. The shape-changeable mouse according to claim 1 wherein said second casing and said positioning part are integrally formed.

17. The shape-changeable mouse according to claim 1 wherein said positioning part of said second casing further comprises a third positioning hole, wherein when said positioning post is inserted into said third positioning hole of said positioning part, a third angle is defined between said first casing and said second casing.

18. A shape-changeable mouse, comprising:
a first casing comprising a convex structure;
a second casing comprising a first concave structure and a positioning part, wherein said convex structure is accommodated within said first concave structure, and said positioning part has a first positioning hole and a second positioning hole;
a push rod pivotally coupled with said first casing and said second casing;
a sliding element penetrated through said first casing and located at a side of said push rod, and comprising a positioning post, wherein when said positioning post is inserted into said first positioning hole of said positioning part, a first angle is defined between said first casing and said second casing, wherein after said sliding element is pushed by said push rod and said positioning post is detached from said first positioning hole, if said first casing is rotated relative to said second casing and said positioning post is inserted into said second positioning hole of said positioning part, a second angle is defined between said first casing and said second casing; and
a third casing for storing a sensor, wherein said third casing is pivotally coupled with said second casing, and said third casing is rotatable relative to said second casing, so that said third casing lies flat on a sensing surface.

19. The shape-changeable mouse according to claim 18 wherein said sensor is an optical sensor.

20. The shape-changeable mouse according to claim 18 wherein said second casing further comprises a second concave structure for accommodating said third casing.

21. The shape-changeable mouse according to claim 18 further comprising a damper hinge, wherein said second casing and said third casing are pivotally coupled with each other through said damper hinge.

22. The shape-changeable mouse according to claim 18 further comprising two buttons, a main circuit board and a battery holder, which are disposed within said second casing.

23. The shape-changeable mouse according to claim 18 further comprising two buttons and a main circuit board, which are disposed within said second casing, wherein said first casing is a battery box for storing a battery.

24. The shape-changeable mouse according to claim 18 further comprising a first elastic element, wherein a first end of said first elastic element is sustained against said sliding element, wherein when said sliding element is pushed by said push rod, said first elastic element is compressed by said sliding element to result in a first elastic potential energy for restoring said sliding element.

25. The shape-changeable mouse according to claim 24 wherein said first elastic element is a compression spring.

26. The shape-changeable mouse according to claim 24 further comprising a second elastic element, wherein said push rod comprises a push block, said second elastic element is sheathed around said push rod, and a first end of said second elastic element is sustained against said push block, wherein when said sliding element is pushed by said push rod, said second elastic element is compressed by said push block to result in a second elastic potential energy for restoring said push rod.

27. The shape-changeable mouse according to claim 26 wherein said second elastic element is a compression spring.

28. The shape-changeable mouse according to claim 26 wherein a second end of said second elastic element is sustained against said positioning part of said second casing.

29. The shape-changeable mouse according to claim 26 wherein said second casing further comprises a perforation, and said push block is penetrated through said perforation, wherein said push block has a pressing surface for moving said push rod, and said push rod is pushed forward through said pressing surface.

30. The shape-changeable mouse according to claim 24 wherein a second end of said first elastic element is sustained against an inner wall of said convex structure of said first casing.

31. The shape-changeable mouse according to claim 24 wherein a stopping piece is disposed within said convex structure of said first casing, wherein a second end of said first elastic element is sustained against said stopping piece.

32. The shape-changeable mouse according to claim 18 wherein said positioning part is a metal piece.

33. The shape-changeable mouse according to claim 18 wherein said second casing and said positioning part are integrally formed.

34. The shape-changeable mouse according to claim 18 wherein said positioning part of said second casing further comprises a third positioning hole, wherein when said positioning post is inserted into said third positioning hole of said positioning part, a third angle is defined between said first casing and said second casing.
